(19) United States
(12) Patent Application Publication
(10) Pub. No.: US 2023/0107468 A1
(43) Pub. Date: Apr. 6, 2023

(54) INTELLIGENT PET TOILET

(71) Applicant: Pet Life (Beijing) Technology Co., Ltd., Beijing (CN)

(72) Inventors: Yazhou Wang, Beijing (CN); Ming Xu, Changsha (CN); Yuefu Wang, Beijing (CN); Shuqiao Zhou, Liuyang (CN); Xiaolv Tang, Beijing (CN); Xiaohui Wang, Beijing (CN); Zhaopu Sun, Yuzhou (CN); Xiaoling Qiu, Chengdu (CN)

(73) Assignee: Pet Life (Beijing) Technology Co., Ltd., Beijing (CN)

(21) Appl. No.: 17/962,562

(22) Filed: Oct. 10, 2022

(30) Foreign Application Priority Data
Oct. 20, 2021 (CN) 202122532552.5

(51) Int. Cl. A01K 1/01

(52) U.S. Cl. CPC A01K 1/011

(57) ABSTRACT

The present disclosure discloses an intelligent pet toilet. The intelligent pet toilet includes a main body; a door I is arranged on an outer wall of the main body; an inner wall of the door I is rotatably connected with a door II; a top outer wall of the main body is fixedly connected with a control panel; a cat litter storage chamber door is arranged on a top inner wall of the main body; a top of the inner wall of the main body is fixedly connected with a cat litter storage chamber; the inner wall of the main body is fixedly connected with a cat litter storage chamber motor; the inner wall of the main body is provided with a sensing device; the inner wall of the main body is fixedly connected with a pedal. The intelligent pet toilet is flushable.

### TECHNICAL FIELD

The present disclosure relates to the technical field of pet toilets, in particular, to an intelligent pet toilet.

### BACKGROUND

In recent years, with the improvement of the living standard, the number of pets is on the rise. Pets also bring some troubles in terms of hygiene, especially pet feces, while they bring people joy. At present, intelligent cat toilets sold in China are basically imitating foreign products. There are two main types of cat toilets: The first type is a rotatable intelligent cat toilet. A cat litter box of this type of product collects cat feces into a feces storage box which is cleaned by a user at a regular interval of 3-7 days. The second type is a washable intelligent cat toilet. This type of product uses plastic cat litter. A shovel automatically shovels the feces in the cat litter into a crushing box. Water is added for crushing the feces, and the feces is discharged into a sewer. The plastic cat litter is then flushed to achieve a repeated use purpose.

During use of the two existing intelligent cat toilets, the feces tends to be stuck to an inner wall and the shovel of the cat toilet. If a cat has soft feces, the feces will be stuck to every part of the toilet, which brings additional cumbersome cleaning work to the user. At the same time, due to the long cleaning cycle, the toilets difficultly meet the needs of a family raising many cats.

### SUMMARY

The present disclosure aims to provide an intelligent pet toilet, and solves the technical problem of additional cumbersome cleaning work of a user.

In order to achieve the above purpose, the present disclosure provides the following technical solution: An intelligent pet toilet includes a main body, wherein a door I is arranged on an outer wall of the main body; an inner wall of the door I is rotatably connected with a door II; a top outer wall of the main body is fixedly connected with a control panel; a cat litter storage chamber door is arranged on a top inner wall of the main body; a top of the inner wall of the main body is fixedly connected with a cat litter storage chamber; the inner wall of the main body is fixedly connected with a cat litter storage chamber motor; the inner wall of the main body is provided with a sensing device; the inner wall of the main body is fixedly connected with a pedal; a crushing box maintenance opening is formed in an inner wall of the pedal; the top of the inner wall of the main body is provided with a power supply; the inner wall of the main body is fixedly connected with a camera; a wiring end of the camera is electrically connected to a wiring end of the power supply; and the inner wall of the main body is fixedly connected with a pan.

Preferably, a feces falling opening is formed in the inner wall of the main body; a bottom of the inner wall of the main body is fixedly connected with a crushing mechanism; and the crushing mechanism is located below the crushing box maintenance opening.

Preferably, the inner wall of the main body is fixedly connected with a water tank; an inner wall of the water tank is fixedly connected with a drainage motor; a bottom of the inner wall of the water tank is fixedly connected with a drainage assembly; and the inner wall of the main body is fixedly connected with a water inlet pipe.

Preferably, the inner wall of the main body is fixedly connected with a discharge pipe; and the discharge pipe is located below the pan. Preferably, a discharge port is formed in one end of the discharge pipe away from the crushing mechanism.

Preferably, a bottom outer wall of the main body is fixedly connected with supporting legs.

Compared with the related art, the intelligent pet toilet provided by the present disclosure has the following beneficial effects.

1. According to the intelligent pet toilet provided by the present disclosure, the intelligent pet toilet is flushable. After it is sensed that a cat poops and then leaves, the intelligent pet toilet automatically flushes all of feces in the pan into the crushing box for crushing, and discharges the feces into a sewer. Soft feces will not be stuck to the wall, and feces in any state can be cleaned without manual cleaning. The trouble that a user cleans the feces of the cat is solved.

2. According to the intelligent pet toilet provided by the present disclosure, it only takes a few minutes to clean the toilet at one time. The cleaning duration is short. The intelligent pet toilet is suitable for a family raising many cats. Furthermore, there is no moving part within a reachable range of a cat, so that the safety of the cat during movement is improved.

### BRIEF DESCRIPTION OF THE DRAWINGS

FIG. 1 is a schematic structural diagram of the present disclosure;

FIG. 2 is a schematic structural diagram of the present disclosure;

FIG. 3 is a sectional view I of the present disclosure; and

FIG. 4 is a sectional view II of the present disclosure.

In the drawings: 1: main body; 2: door I; 3: door II; 4: control panel; 5: cat litter storage chamber door; 6: cat litter storage chamber; 7: sensing device; 8: power supply; 9: camera; 10: pedal; 11: crushing box maintenance opening; 12: feces falling opening; 13: crushing mechanism; 14: cat litter storage chamber motor; 15: drainage motor; 16: drainage assembly; 17: discharge pipe; 18: water inlet pipe; 19: pan; 20: discharge port; and 21: supporting leg.

### DETAILED DESCRIPTION OF THE EMBODIMENTS

The technical solutions in the embodiments of the present disclosure will be clearly and completely described below in combination with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work belong to the protection scope of the present disclosure.

### Embodiments

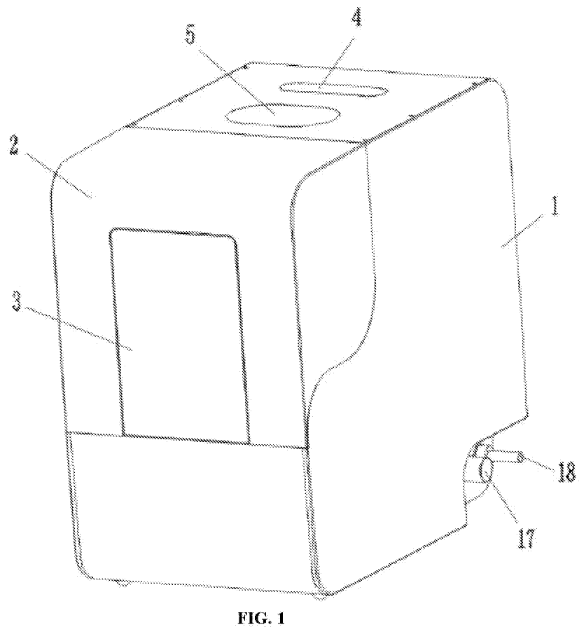

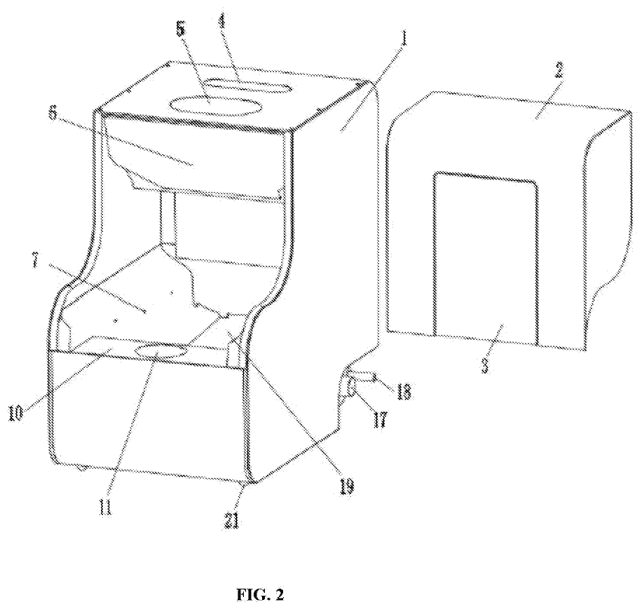

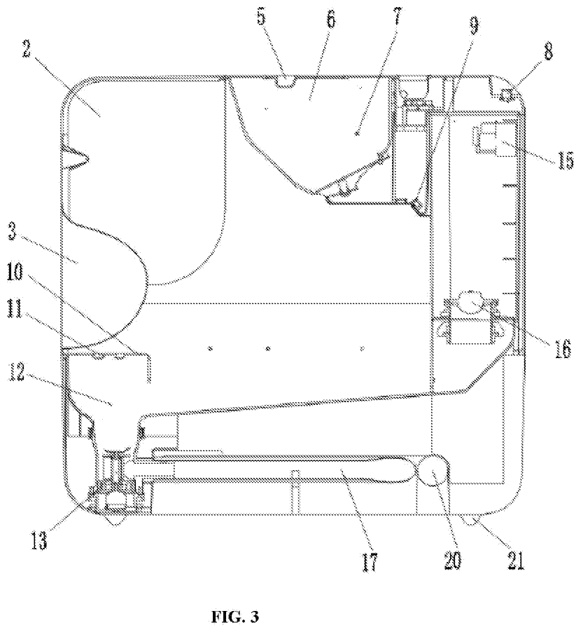

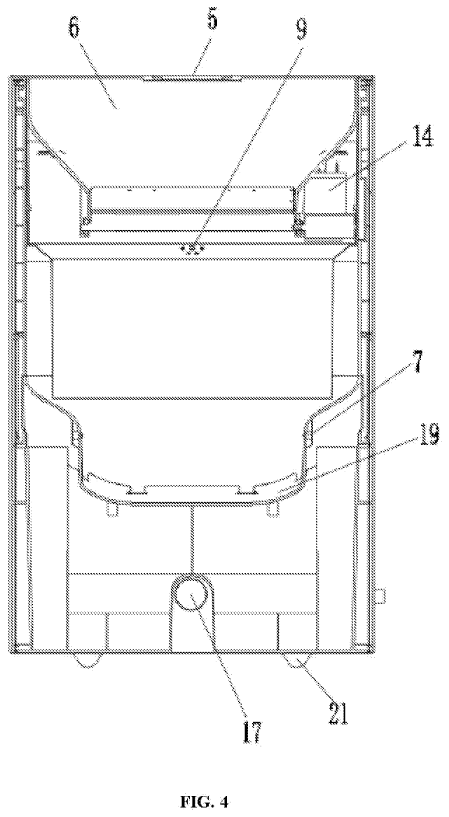

Referring to FIGS. 1-4, the present disclosure provides a technical solution: a main body 1. A door I 2 is arranged on an outer wall of the main body 1. An inner wall of the door I 2 is rotatably connected with a door II 3. A top outer wall of the main body 1 is fixedly connected with a control panel 4. A cat litter storage chamber door 5 is arranged on a top inner wall of the main body 1. A top of the inner wall of the main body 1 is fixedly connected with a cat litter storage chamber 6. The inner wall of the main body 1 is fixedly connected with a cat litter storage chamber motor 14. The inner wall of the main body 1 is provided with a first sensing device 7. The inner wall of the main body 1 is fixedly connected with a pedal 10. A crushing box maintenance opening 11 is formed in an inner wall of the pedal 10. The top of the inner wall of the main body 1 is provided with a power supply 8. The inner wall of the main body 1 is fixedly connected with a camera 9. A wiring end of the camera 9 is electrically connected to a wiring end of the power supply 8. The inner wall of the main body 1 is fixedly connected with a pan 19. A feces falling opening 12 is formed in the inner wall of the main body 1. A bottom of the inner wall of the main body 1 is fixedly connected with a crushing mechanism 13. The crushing mechanism 13 is located below the crushing box maintenance opening 11. The inner wall of the main body 1 is fixedly connected with a water tank. An inner wall of the water tank is fixedly connected with a drainage motor 15. A bottom of the inner wall of the water tank is fixedly connected with a drainage assembly 16. The inner wall of the main body 1 is fixedly connected with a water inlet pipe 18. The inner wall of the main body 1 is fixedly connected with a discharge pipe 17. The discharge pipe 17 is located below the pan 19. A discharge port 20 is formed in one end of the discharge pipe 17 away from the crushing mechanism 13. A bottom outer wall of the main body 1 is fixedly connected with supporting legs 21.

In this implementation solution, after the sensing device 7 detects a cat entering the toilet, the intelligent pet toilet is in a standby state. A treading support is provided for the cat through the pedal 10. The device in the crushing box is convenient to maintain through the crushing box maintenance opening 11. When the sensing device 7 detects the cat leaving, the drainage motor 15 is started. At this time, water in the water tank is drained into the pan 19 through the drainage assembly 16. The pan 19 is mounted in a certain inclination angle, so that it is convenient to flush all of feces in the pan 19 with water into the crushing box via the feces falling opening 12. After the feces enters the crushing box, the crushing mechanism 13 is started. The feces is crushed through the crushing mechanism 13 and is discharged into the discharge pipe 17. After the pan 19 is flushed to be clean, the cleaning work ends. At this time, cat litter is discharged from the cat litter storage chamber 6. The camera 9 takes a picture of the cat under the lighting of a lamp strip. A user can set a flushing mode and the use amount of cat litter through the control panel 4, or can network the toilet, remotely control the toilet through a mobile phone, and watch the toileting process of the cat on the mobile phone Small dogs can also use this toilet after the cat litter discharge function is shut down. It is noted here that the intelligent pet toilet is powered by 12V direct current, so that electrical safety is achieved. The voltage of the 12V direct current will not injure a pet and a user even if the insulation function decreases.

Working principle: After the sensing device 7 detects a cat entering the toilet, the intelligent pet toilet is in a standby state. When the sensing device 7 detects the cat leaving, the drainage motor 15 is started. At this time, water in the water tank is drained into the pan 19 through the drainage assembly 16. The pan 19 is mounted in a certain inclination angle, so that it is convenient to flush all of feces in the pan 19 with water into the crushing box via the feces falling opening 12. After the feces enters the crushing box, the crushing mechanism 13 is started. The feces is crushed through the crushing mechanism 13 and is discharged into the discharge pipe 17. After the pan 19 is flushed to be clean, the cleaning work ends. At this time, cat litter is discharged from the cat litter storage chamber 6. The camera 9 takes a picture of the cat under the lighting of a lamp strip. A user can set a flushing mode and the use amount of cat litter through the control panel 4, or can network the toilet, remotely control the toilet through a mobile phone, and watch the toileting process of the cat on the mobile phone Small dogs can also use this toilet after the cat litter discharge function is shut down.

It should be noted that in this context, relational terms such as first and second are used merely to distinguish one entity or operation from another entity or operation, instead of necessarily requiring or implying that these entities or operations have any of these actual relationships or orders. Furthermore, terms “include”, “including” or any other variants are meant to cover non-exclusive inclusions, so that a process, method, object or device that includes a series of elements not only includes those elements, but also includes other elements which are not definitely listed, or further includes inherent elements of this process, method, object or device.

Although the embodiments of the present disclosure have been shown and described, it will be understood by those of ordinary skill in the art that various changes, modifications, substitutions, and transformations can be made to these embodiments without departing from the principle and spirit of the present disclosure. The scope of the present disclosure is defined by the attached claims and their equivalents.

What is claimed is:

1. An intelligent pet toilet, comprising a main body (1), wherein a door I (2) is arranged on an outer wall of the main body (1); an inner wall of the door I (2) is rotatably connected with a door II (3); a top outer wall of the main body (1) is fixedly connected with a control panel (4); a cat litter storage chamber door (5) is arranged on a top inner wall of the main body (1); a top of the inner wall of the main body (1) is fixedly connected with a cat litter storage chamber (6); the inner wall of the main body (1) is fixedly connected with a cat litter storage chamber motor (14); the inner wall of the main body (1) is provided with a sensing device (7); the inner wall of the main body (1) is fixedly connected with a pedal (10); a crushing box maintenance opening (11) is formed in an inner wall of the pedal (10); the top of the inner wall of the main body (1) is provided with a power supply (8); the inner wall of the main body (1) is fixedly connected with a camera (9); a wiring end of the camera (9) is electrically connected to a wiring end of the power supply (8); and the inner wall of the main body (1) is fixedly connected with a pan (19).

2. The intelligent pet toilet according to claim 1, wherein a feces falling opening (12) is formed in the inner wall of the main body (1); a bottom of the inner wall of the main body (1) is fixedly connected with a crushing mechanism (13); and the crushing mechanism (13) is located below the crushing box maintenance opening (11).

3. The intelligent pet toilet according to claim 1, wherein the inner wall of the main body (1) is fixedly connected with a water tank; an inner wall of the water tank is fixedly connected with a drainage motor (15); a bottom of the inner wall of the water tank is fixedly connected with a drainage assembly (16); and the inner wall of the main body (1) is fixedly connected with a water inlet pipe (18).

4. The intelligent pet toilet according to claim 1, wherein the inner wall of the main body (1) is fixedly connected with a discharge pipe (17); and the discharge pipe (17) is located below the pan (19).

5. The intelligent pet toilet according to claim 4, wherein a discharge port (20) is formed in one end of the discharge pipe (17) away from the crushing mechanism (13).

6. The intelligent pet toilet according to claim 1, wherein a bottom outer wall of the main body (1) is fixedly connected with supporting legs (21).
